(19) United States
(12) Patent Application Publication
(10) Pub. No.: US 2013/0074734 A1
(43) Pub. Date: Mar. 28, 2013

(54) Method for Surface Modification of Titanium Dioxide Pigment

(71) Applicants: Uwe Wilkenhoner, Wuppertal (DE); Jurgen Bender, Monheim (DE)

(72) Inventors: Uwe Wilkenhoner, Wuppertal (DE); Jurgen Bender, Monheim (DE)

(21) Appl. No.: 13/623,537

(22) Filed: Sep. 20, 2012

Related U.S. Application Data
(60) Provisional application No. 61/542,565, filed on Oct. 3, 2011.

(30) Foreign Application Priority Data
Sep. 22, 2011 (DE) 102011113896.3

(51) Int. Cl. C09C 1/36

(52) U.S. Cl. 106/446; 106/436; 106/442; 106/499

(57) ABSTRACT

The invention relates to a method for the surface modification of titanium dioxide pigment and to its use, particularly in coatings, for interior and exterior walls (emulsion paints) and in water-borne paint systems. The method for surface modification is based on a titanium dioxide pigment that has been provided with a fluffily structured surface coating and where the fluffily structure of the surface coating is at least partially compacted, preferably by exposing the pigment particles to high shear and impact forces. The pigment particles are preferably coated with silicon oxide and/or aluminium oxide. The method according to the invention preferably reduces the specific surface area (BET) by roughly 30%. The pigment according to the invention can be used to optimise the rheological properties and the open time of the paint.

### CROSS REFERENCE TO RELATED APPLICATIONS

This application claims the benefit of German Patent Application Serial No. DE 1020111138963 filed Sep. 22, 2011 as well as U.S. Provisional Application Ser. No. 61/542,565 filed Oct. 3, 2011.

### BACKGROUND

1. Field of the Invention

The invention relates to a method for the surface modification of titanium dioxide pigment and to the use of the titanium dioxide pigment, particularly in coatings for interior and exterior walls (emulsion paints) and in water-borne paints.

2. Description of Related Art

Due to its high refractive index, titanium dioxide is generally the most important white pigment in the fields of application paints and coatings, plastics, paper and fibres. Of decisive importance for use in the different areas are not only the optical properties, such as lightening power, tone or hiding power, but also the photostability (weather resistance) of the pigment and other surface properties, such as dispersibility. The properties of the titanium dioxide pigment particles are therefore usually adapted to the specific fields of application by means of an inorganic and/or organic surface coating.

Coatings for interior and exterior walls, referred to as emulsion paints below, usually contain not only titanium dioxide pigment, but also substantial quantities of what are known as extenders, such as calcium carbonate, diatomaceous earth or barium sulphate. One of the tasks of the extenders is to keep the pigment particles separate from each other in the paint, such that every single pigment particle can be optically effective, if possible. In this way, high values of 70% and more can be obtained for the total pigment (plus extender) volume concentration.

Titanium dioxide pigments for use in emulsion paints must demonstrate high hiding power (opacity), on the one hand, and good dispersibility, on the other. To achieve the high hiding power, they are customarily provided with a voluminous, porous, fluffy coating of silicon oxide and aluminium oxide. The voluminous, fluffy structure of the surface coating acts as a spacer between the individual particles and leads to increased hiding power as a result of the dry-hiding effect. In addition, the porous surface coating of the pigment influences the liquid retention capacity, and thus the viscosity, of the paint. U.S. Pat. 3,410,708 and U.S. Pat. No. 3,591,398 disclose methods for producing porous SiO₂ and Al₂O₃ surface coatings.

When applying emulsion paint to a wall, it is important, on the one hand, for the paint to have both a certain viscosity and a certain thixotropic behaviour, such that the paint directly adheres well on the vertical surface, but can also easily be spread. On the other hand, a long open time of the paint is desirable, in order to permit easy overpainting of wet coating films. Attempts to optimise these contradictory properties are customarily made by using various additives, such as dispersants and thickeners.

There is a need to simplify the formulation of the paints and reduce the number and/or quantity of necessary additives.

### BRIEF DESCRIPTION OF THE INVENTION

The object of the invention is to indicate a method by means of which a titanium dioxide pigment can be produced that assumes tasks of some of the additives in emulsion paints, preferably the optimisation of rheological properties (e.g. viscosity) and the open time of the paint.

The object is solved by a method for the surface modification of titanium dioxide pigment particles, characterised in that:

a) the particles are initially provided with an inorganic surface coating displaying a fluffy structure, and
b) the particles are subsequently exposed to high shear and impact forces, such that the fluffy structure of the inorganic surface coating is at least partially compacted.

The object is further solved by titanium dioxide pigment particles, characterised in that the particles are provided with an inorganic surface coating of fluffy structure in a first step, and in that the fluffy structure of the surface coating is subsequently compacted by exposure to mechanical energy in a second step.

Further advantageous embodiments of the invention are indicated in the sub-claims.

### BRIEF DESCRIPTION OF THE DRAWINGS

For a more complete understanding of the present invention and for further advantages thereof, reference is now made to the following description taken in conjunction with the accompanying drawings in which:

FIG. 1 is a transmission electron microscope photograph of a starting pigment used in the current invention; and

FIG. 2 is a transmission electron microscope photograph of a treated pigment of the current invention.

### DESCRIPTION OF THE PREFERRED EMBODIMENTS

In the context of the description of the surface coating of titanium dioxide particles, the term “oxide” is also to be taken to mean the corresponding hydrous oxides and the corresponding hydrates, here and below. All data disclosed below regarding concentration in % by weight or % by volume, etc. are to be interpreted as also including all values lying in the range of the respective measuring accuracy known to the person skilled in the art. The term “raw titanium dioxide pigment particles” refers to titanium dioxide pigment particles that have not yet been subjected to any surface treatment.

The invention relates to a method for the surface modification of titanium dioxide pigment, as a result of which the open time and viscosity of the emulsion paint produced by the method are influenced in parallel, such that, for example, the open time of the paint is extended while the viscosity remains unchanged, or the viscosity of the paint is increased while the open time remains unchanged.

The invention is based on a titanium dioxide pigment that has been coated with silicon oxide and/or aluminium oxide of fluffy structure, referred to as the “starting pigment” below. The corresponding methods for producing porous surface coatings are known and disclosed in U.S. Pat. No. 3,410,708 and U.S. Pat. No. 3,591,398, the content of which are incorporated herein by reference as examples of such methods. Customarily, an aqueous suspension of raw titanium dioxide pigment particles is produced, and the coating substances are added in the form of an aqueous solution of corresponding salts. The substances are precipitated with a fluffy structure by setting a suitable pH value. In the known methods, a substantial portion of the coating substances—roughly 20 to 30% by weight—is usually not precipitated out on the particle surface, but separately in the form of flaky aggregates. The aggregates cannot be separated from the pigment particles and remain in the starting pigment.

The total quantity of precipitated coating substances in the starting pigment is preferably in the region of at least 10% by weight, calculated as oxide and referred to the total pigment. The silicon oxide content is preferably 5 to 20% by weight, and the aluminium oxide content is preferably 0.5 to 8% by weight, referred to the total pigment. The specific surface area (according to BET) of the starting pigment is preferably about 40 to 80 m²/g. The oil absorption of the starting pigment (measured according to DIN EN ISO 787-5) is preferably about 20 to 80 g/100 g pigment. The bulk density of the pigment is preferably about 0.4 to 0.7 g/cm³.

In the framework of the invention, the starting pigment is surface-modified by being exposed to high shear and impact forces in a suitable device, preferably in a device of the stator/rotor type. A mixing vessel is preferred that has mixing tools moving in opposite directions to each other, particularly rotating, and where high shear and impact forces are applied. The mixing vessel can, for example, be a drum with rotating mixing tools, or a rotating drum with stationary or rotating mixing tools. The intensity of the rotational movement of the mixing vessel can be described by the dimensionless Froude number.

The dimensionless Froude number Fr_{P} is defined as the ratio of centrifugal force FC to gravitational force F acting on the individual particle (P), i.e. Fr_{P}=FC/F=(ωₚ²*Rₚ)/g, where ω_{P} is the angular frequency, R_{P} the radius of the particle flight path curve, and g the gravitational acceleration. The Froude number thus correlates with the rpm speed of the rotor. For simplification, the particle motion in the mixing vessel can be described using what is known as the tool Froude number Fr_{T}, i.e. Fr_{T}=(ω_{T}²*R_{T})/g, where ω_{T} is the angular frequency, R_{T} the outer radius of the mixing tools, and g the gravitational acceleration. According to the invention, the tool Froude number Fr_{T} is preferably in the region of values of roughly >10, particularly roughly >30 and preferably roughly >100.

In a preferred embodiment, the specific energy input (referred to the pigment mass) when modifying the surface of the starting pigment is between 1 and 10,000 kJ/kg, particularly between 10 and 5,000 kJ/kg and preferably between 100 and 2,000 kJ/kg.

In a preferred embodiment, the device used according to the invention for surface modification of the starting pigment is operated at a rotor peripheral speed of 0.1 to 100 m/s, preferably at a rotor peripheral speed of 5 to 50 m/s.

The duration of the method for surface modification of the starting pigment can vary within broad limits. The duration of the method generally varies in the range from 0.5 to 100 minutes, particularly 1 to 30 minutes and preferably 2 to 10 minutes.

The surface modification of the starting pigment according to the invention leads, on the one hand, to compaction and/or extensive adhesion of the coating substances precipitated separately in the form of flaky agglomerates to the surface of the pigment particles and, on the other hand, to at least partial compaction of the surface of the pigment particles. The surface-modified pigment according to the invention differs from the starting pigment by having a smaller specific surface area (BET), lower oil absorption and a higher bulk density. The specific surface area (BET) of the starting pigment is preferably reduced by up to roughly 30 to 40% with the help of the method according to the invention. In a preferred embodiment of the invention, the specific surface area (BET) of the starting pigment is reduced from greater than roughly 60 m²/g to less than roughly 40 m²/g. The oil absorption (to DIN EN ISO 787-5) of the starting pigment changes at the same time, preferably from approx. 45 g oil/100 g pigment to approx. 36 g oil/100 g pigment. A preferred version of the method described involves the use of organic substances, with which the pigment can be coated during treatment. The use of suitable organic additives makes it possible to further reduce the BET surface, and thus the oil absorption, of the pigment treated by the method described. The additives can be added in solid or liquid form. Particularly suitable in this respect are hydrophobing additives, such as waxes with or without further chemical functionalisation, polyolefins or similar substances. This (semi-)hydrophobicity additionally brings about the desired rheological effects. Furthermore, use can be made of familiar dispersing additives or other auxiliaries customary in paint technology, e.g. for rheology, defoaming, wetting, etc. The quantity of added organic additives is preferably 0.05 to 30% by weight, particularly 0.5 to 10% by weight, referred to the starting pigment.

The titanium dioxide pigment particles produced according to the invention are particularly suitable for use in interior and exterior emulsion paints and in water-borne paint systems.

### EXAMPLE

The invention is described in more detail on the basis of the following example, although this is not to be interpreted as a limitation of the scope of the invention.

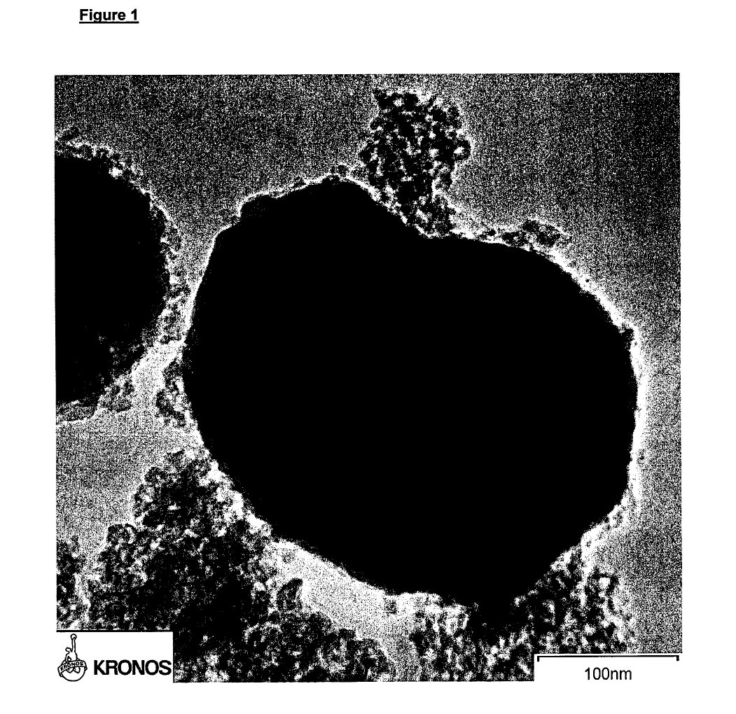

The pigment grade used as the starting pigment was KRONOS 2044, a pigment post-treated with a high quantity of SiO₂ and Al₂O₃. The KRONOS 2044 starting pigment displays a fluffy surface coating of >10% by weight SiO₂ and >3% by weight Al₂O₃, where large portions of the surface coating material are present alongside the TiO₂ surface (FIG. 1, transmission electron microscope photograph).

The specific surface area (BET) of the KRONOS 2044 pigment is roughly 60 to 65 m²/g. The oil absorption is roughly 45 g/100 g pigment. The pigment (approx. 300 g) was put into the “Nobilta NOB-130” particle coater from Hosokawa Alpine and then exposed to controlled shear action.

The pigment was mechanically treated in the device at a speed of approx. 2,800 to 3,200 rpm and a specific energy input of roughly 3,000 kJ/kg TiO₂. The product temperature was limited to <80° C. by cooling the housing with water. The process time was 3 to 5 minutes of intensive shearing. The tool Froude numbers used in this process were between 450 and 900.

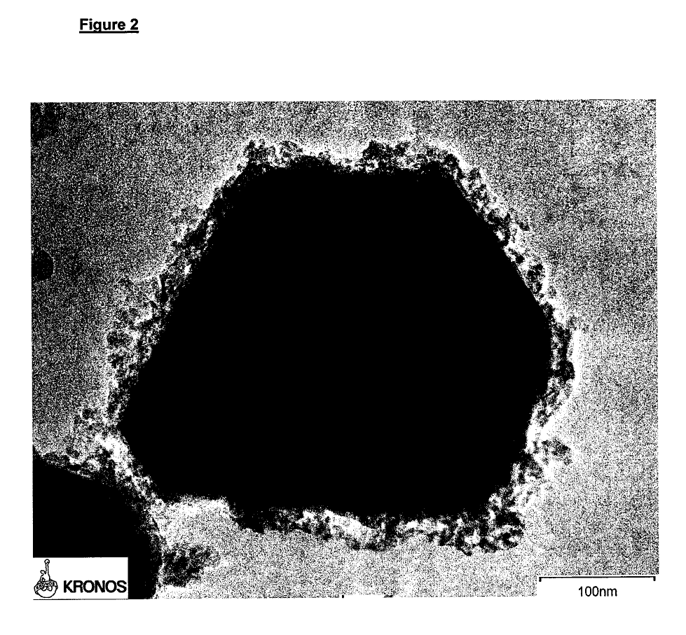

The pigment mechanically treated in this way displayed a specific surface area (BET) of 30 to 38 m²/g and an oil absorption of roughly 37 g/100 g pigment. FIG. 2 shows a transmission electron microscope photograph of the treated pigment.

The mechanically treated starting pigment (Example) and, in parallel, the untreated starting pigment (Reference Example) were each used to produce an interior emulsion paint with the formulation indicated in Table 1.

TABLE 1

| | |
|---|---|
| Water | 27.45% by weight |
| Calgon N neu (dispersant) | 0.05% by weight |
| Dispex N 40 (dispersant) | 0.30% by weight |
| Agitan 315 (defoamer) | 0.20% by weight |
| Acticid MBS (algicide/fungicide) | 0.40% by weight |
| TiO₂ pigment | 22.00% by weight |
| Steamat (extender) | 7.00% by weight |
| Socal P2 (extender) | 2.00% by weight |
| Omyacarb 2-GU (extender) | 11.80% by weight |
| Omyacarb 5-GU (extender) | 15.50% by weight |
| Celite 281 SS (extender) | 2.00% by weight |
| Tylose MH 30000 YG8 (cellulose) | 0.30% by weight |
| Mowilith LDM 1871 (binder) | 11.00% by weight |

The test paints were each tested as regards their brightness L* (white), tone b* (white), contrast ratio CR, open time and viscosity (Table 2).

### Test Methods

The white interior emulsion paint (test paint) produced in accordance with the specified formulation was applied to Morest charts with a 300 μm grooved doctor blade by means of a film applicator at a speed of 12.5 mm/s. The drawdowns were dried in the laboratory at 23° C. over night.

The brightness L* (white) and tone b* (white) of the white coating were measured with the Color-view spectrophotometer from Byk-Gardner. To determine the contrast ratio, the white interior emulsion paint (test paint) produced in accordance with the specified formulation was applied to Morest contrast charts with a 300 μm grooved doctor blade by means of an automatic film applicator at a speed of 12.5 mm/s. The Y over black background (Y_{(black)}) and Y over white background (_{Y}(_{white)}) colour values were then measured three times each with the Color-view spectrophotometer. The contrast ratio was calculated according to the following formula:

CR[%]=Y_{(black)}/Y_{(white)}×100

To determine the open time of the interior emulsion paint produced, a paint film with a thickness of 300 μm was applied to a Morest chart, using a variable-gap doctor blade, after which the time to surface-drying of the paint film in minutes was determined. The paint film was considered to be “surface-dry” as soon as it was tack-free and a fingerprint no longer left a permanent impression.

The viscosity of the interior emulsion paint was measured with a viscometer from Brookfield (Model KU-2) and indicated in Krebs Units (KU). The specific surface area (BET) of the pigment was measured by the static volumetric principle, using a Tristar 3000 from Micromeritics.

The oil absorption of the pigment was determined in accordance with DIN EN ISO 787-5.

TABLE 2

| | L* | b* | | Open | | | Oil |
|---|---|---|---|---|---|---|---|
| | (over | | CR | time | Viscosity | BET | absorption |
| | white) | | [%] | [min] | [KU] | [m²/g] | [g/100 g] |
| Example | 97.6 | 2.2 | 99.1 | 34 | 122 | 39 | 36.9 |
| Reference | 96.9 | 2.2 | 98.9 | 24 | 134 | 61 | 45.0 |
| Example | | | | | | | |

It can be seen that the paint containing the pigment treated according to the invention displays a longer open time and lower viscosity compared to the Reference Example, while the optical properties (L*, b*, CR) remain unchanged. Moreover, the transmission electron microscope photographs of the untreated starting pigment (FIG. 1) and the starting pigment treated according to the invention (FIG. 2) clearly show that the fluffy coating of the particles is extensively compacted on the particle surface by the mechanical treatment according to the invention. At the same time, the separate, flaky aggregates of the coating material are likewise extensively attached to the particle surface and compacted.

The surface treatment method according to the invention compacts the surface structure of the pigments and thus reduces the water demand (see BET, oil absorption and electron microscope photographs in FIGS. 1 and 2). The rheological properties of the user system (drying time and viscosity) can be improved in this way, while simultaneously retaining the optical properties (L*, b* and contrast ratio CR).

Other alterations and modifications of the invention will likewise become apparent to those of ordinary skill in the art upon reading the present disclosure, and it is intended that the scope of the invention disclosed herein be limited only by the broadest interpretation of the appended claims to which the inventors are legally entitled.

What is being claimed is:

1. A method for the surface treatment of titanium dioxide pigment particles, comprising:
a) providing titanium dioxide pigment particles having an inorganic surface coating displaying a fluffy structure, and
b) subsequently exposing the particles to high shear and impact forces sufficient to compact the fluffy structure of the inorganic surface coating.

2. The method of claim 1, wherein a mixing device of the rotor/stator type is used in Step b).

3. The method of claim 2 wherein the high shear and impact forces result in a specific energy input of from about 1 to about 10,000 kJ/kg.

4. The method of claim 3 wherein the high shear and impact forces result in a specific energy input of from about 10 to about 5,000 kJ/kg.

5. The method of claim 4 wherein the high shear and impact forces result in a specific energy input of from about 100 to about 2,000 kJ/kg.

6. The method of claim 2 wherein the mixing device is operated at a rotor peripheral speed of from about 0.1 to about 100 m/s for a duration of from about 0.5 to about 100 minutes.

7. The method of claim 6 wherein the mixing device is operated at a rotor peripheral speed of from about 5 to about 50 m/s for a duration of from about 1 to about 30 minutes.

8. The method of claim 2, wherein the mixing device is operated with a tool Froude number of greater than about 10.

9. The method of claim 8, wherein the mixing device is operated with a tool Froude number of greater than about 30.

10. The method of claim 9, wherein the mixing device is operated with a tool Froude number of greater than about 100.

11. The method according to 1, wherein the particles in step a) have a specific surface area (BET) greater than roughly 60 m²/g and in step b) the specific surface area of the particles is reduced to less than roughly 40 m²/g by the exposure to shear and impact forces.

12. The method according to 8, wherein the particles in step a) have a specific surface area (BET) greater than roughly 60 m²/g and in step b) the specific surface area of the particles is reduced to less than roughly 40 m²/g by the exposure to shear and impact forces.

13. The method according to 9, wherein the particles in step a) have a specific surface area (BET) greater than roughly 60 m²/g and in step b) the specific surface area of the particles is reduced to less than roughly 40 m²/g by the exposure to shear and impact forces.

14. The method according to claim 1 wherein the inorganic surface coating comprises a material selected from the group consisting of silicon oxide, aluminium oxide and mixtures thereof.

15. The method according to claim 14, wherein the inorganic surface coating comprises silicon oxide and the amount of silicon oxide in the surface coating is from about 5% to about 20% by weight of the total pigment.

16. The method according to claim 14, wherein the inorganic surface coating comprises aluminium oxide and the amount of aluminium oxide in the surface coating is from about 0.5 to about 8% by weight of the total pigment.

17. The method of claim 1 further comprising the step of coating the particles with one or more organic additives.

18. The method of claim 17, wherein the quantity of the one or more organic additives is from about 0.05 to about 30% by weight based on the starting pigment.

19. The method of claim 18 wherein the quantity of the one or more organic additives is from about 0.5 to about 10% by weight based on the starting pigment.

20. The method of claim 10 wherein:
the inorganic surface coating comprises silicon oxide in an amount of from about 5% to about 20% by weight of the total pigment and aluminium oxide in an amount from about 0.5 to about 8% by weight of the total pigment; and
the particles in step a) have a specific surface area (BET) greater than roughly 60 m²/g and in step b) the specific surface area of the particles is reduced to less than roughly 40 m²/g by the exposure to shear and impact forces.

21. The method of claim 20, further comprising the step of coating the particles with one or more organic additives in an amount from about 0.05 to about 30% by weight based on the starting pigment.

22. The method of claim 21 wherein the quantity of the one or more organic additives is from about 0.5 to about 10% by weight based on the starting pigment.

23. The method of claim 1 wherein the particles in step a) have a specific surface area of from about 40 to about 80 m²/g, an oil absorption of from about 20 to about 80 g/100 g pigment, and a bulk density of from about 0.4 to 0.7 g/cm³.

24. The method of claim 1 wherein the inorganic surface coating is at least about 10% by weight based on the total pigment.

25. The method of claim 1 wherein the pigment has a specific surface area and step b) reduces the specific surface area of the particles more than about 30%.

26. The method of claim 20 wherein:
the particles in step a) have an oil absorption of from about 20 to about 80 g/100 g pigment and and a bulk density of from about 0.4 to 0.7 g/cm³;
the mixing device is operated at a rotor peripheral speed of from about 5 to about 50 m/s for a duration of from about 1 to about 30 minutes; and
the high shear and impact forces in Step b) result in a specific energy input of from about 100 to about 2,000 kJ/kg.

27. The method of claim 26 further comprising the step of coating the particles with one or more organic additives in an amount from about 0.5 to about 10% by weight based on the starting pigment.

28. The method of claim 1 further comprising using the surface-treated particles in a paint system selected from the group consisting of interior emulsion paints, exterior emulsion paints, and water-borne paints.

29. Surface-treated titanium dioxide pigment particles manufactured according to the method of claim 1.
